(19) United States
(12) Patent Application Publication
(10) Pub. No.: US 2026/0041221 A1
(43) Pub. Date: Feb. 12, 2026

(54) METHOD FOR PREDICTING COSMETIC EFFECTS OF INGREDIENTS USING MACHINE LEARNING

(71) Applicant: ELC MANAGEMENT LLC, Melville, NY (US)

(72) Inventor: Christopher Aidan, Austin, TX (US)

(21) Appl. No.: 18/796,871

(22) Filed: Aug. 7, 2024

(51) Int. Cl. A45D 44/00; G06N 20/00; G06T 13/40

(52) U.S. Cl. CPC A45D 44/005; G06N 20/00; G06T 13/40; A45D 2044/007

(57) ABSTRACT

The present disclosure provides a method for predicting cosmetic effects of ingredients using machine learning. A computing device trains a machine learning model using properties of ingredients having known cosmetic effects as predictor feature values and the known cosmetic effects as target feature values. The computing device obtains a set of properties for a new ingredient and applies them to the trained machine learning model to predict cosmetic effects of the new ingredient. Additionally, the computing device generates a formulation for a new beauty product with the new ingredient using a generative AI model trained on existing beauty product formulations. A virtual cosmetic testing system simulates the predicted cosmetic effects on a virtual person over time. The virtual cosmetic testing system presents a display of the virtual person's face and runs a simulation depicting changes to the virtual person's face as the new ingredient is applied.

### TECHNICAL FIELD

The present disclosure relates to predicting and simulating cosmetic effects using machine learning and artificial intelligence techniques, and more particularly, to methods and systems for predicting cosmetic effects of ingredients, simulating their impact over time on virtual models, and generating formulations for new beauty products based on these predictions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The cosmetics industry is constantly evolving, with new ingredients and formulations being developed to address various skin and hair concerns. Consumers are increasingly interested in products that offer specific benefits, such as reducing wrinkles, firming skin, improving hair volume, or controlling frizz. However, the process of developing and testing new cosmetic ingredients and products can be time-consuming and resource-intensive.

Traditionally, cosmetic companies have relied on extensive laboratory testing and human trials to evaluate the efficacy of new ingredients and formulations. These methods, while valuable, often require significant investments of time and money. Additionally, the results of such tests may not always accurately predict how a product will perform across a diverse range of consumers with varying skin types, ages, and environmental factors.

As consumers become more informed and demanding about the products they use, there is a growing need for innovative approaches to cosmetic product development that can deliver targeted, effective solutions more efficiently. Improved methods for predicting and testing the effects of cosmetic ingredients could not only benefit cosmetic companies but also lead to better products for consumers.

### SUMMARY

The advent of machine learning and artificial intelligence technologies has opened up new possibilities in various industries, including cosmetics. These technologies have the potential to revolutionize the way new ingredients and products are developed and tested. By analyzing large datasets of ingredient properties and their known effects, machine learning models can predict the cosmetic effects of new ingredients more quickly and accurately than traditional methods. The use of artificial intelligence (AI) and machine learning (ML) technologies in cosmetology addresses the need to overcome the limitations of traditional cosmetic testing methods, which are often time-consuming and costly. The systems and methods described herein offer comprehensive solutions that leverage AI and ML to predict the cosmetic effects of ingredients, conduct virtual testing, and accelerate the pace of research in cosmetology.

Furthermore, the use of computer simulations and virtual testing environments allows for rapid iteration and optimization of product formulations without the need for extensive physical testing. This approach can reduce the time and cost associated with bringing new cosmetic products to market. The virtual cosmetic testing platform, equipped with a suite of advanced modules including 3D simulation, sensitivity analysis, and ingredient compatibility assessment, offers a safe and cost-effective alternative to traditional testing methods. This platform simulates the effects of cosmetic ingredients and formulations on virtual models, providing a dynamic and insightful evaluation of potential cosmetic outcomes. The use of Monte Carlo simulations, for instance, models the probability of various cosmetic effects, thereby offering a nuanced understanding of ingredient efficacy. This approach not only reduces the reliance on physical testing but also significantly lowers the time and resources required to evaluate new cosmetic ingredients and formulations.

Moreover, the system introduces an accelerated research methodology that optimizes the research process. By integrating the predictive AI model with the virtual testing platform, and incorporating real-time learning and adjustment modules, this methodology streamlines the development of cosmetic products. It enables researchers and product developers to swiftly iterate on formulations, assess potential outcomes, and refine their approaches based on immediate feedback from virtual tests. This methodology represents a leap forward in research efficiency, which can drastically cut down the time from concept to market for new cosmetic products.

According to an aspect of the present disclosure, a method for predicting cosmetic effects of ingredients using machine learning techniques is provided. The method includes, for each of a plurality of first ingredients having known cosmetic effects, obtaining, by one or more processors, (i) a set of properties of each of the plurality of first ingredients, and (ii) at least one known cosmetic effect of each of the plurality of first ingredients. The method further includes training, by the one or more processors, a machine learning model for predicting cosmetic effects of ingredients using (i) the set of properties of the plurality of first ingredients and (ii) the at least one known cosmetic effect of each of the plurality of first ingredients. The method also includes obtaining, by the one or more processors, a set of properties for a second ingredient having unknown cosmetic effects. The method further includes applying, by the one or more processors, the set of properties for the second ingredient having unknown cosmetic effects to the machine learning model to predict the cosmetic effect for the second ingredient.

According to other aspects of the present disclosure, the method may include one or more of the following features. The method may include simulating, by the one or more processors, effects of the second ingredient on a virtual person over time based on the set of properties for the second ingredient by depicting changes to images of the virtual person's face over time with the second ingredient applied. The method may include generating, by the one or more processors, a formulation for a new beauty product which includes the second ingredient based on the predicted cosmetic effect for the second ingredient. The formulation of the new beauty product may include a plurality of ingredients including the second ingredient and a ratio for each of the plurality of ingredients indicating an amount of each ingredient to include in the new beauty product. The method may include simulating, by the one or more processors, effects of the new beauty product on a virtual person over time by depicting changes to images of the virtual person's face over time with the new beauty product applied. Generating the formulation for the new beauty product may include applying, by the one or more processors, the second ingredient to a generative artificial intelligence (AI) model to generate the formulation of the new beauty product, wherein the generative AI model is trained on existing beauty products and corresponding ingredients of the existing beauty products to learn a relationship between the existing beauty products and the corresponding ingredients. The generative AI model may be further trained to identify a complementary property to the set of properties for the second ingredient, and generate the formulation to include an additional ingredient to the second ingredient having the complementary property. The set of properties and the at least one known cosmetic effect of each of the plurality of first ingredients may be obtained at least in part from sensor data indicating real-time cosmetic effects of the plurality of first ingredients on consumers as the consumers use beauty products with the plurality of first ingredients.

According to another aspect of the present disclosure, a computing device for predicting cosmetic effects of ingredients using machine learning techniques is provided. The computing device includes one or more processors and a non-transitory computer-readable medium storing instructions thereon that, when executed by the one or more processors, cause the computing device to perform operations. The operations include, for each of a plurality of first ingredients having known cosmetic effects, obtaining (i) a set of properties of each of the plurality of first ingredients, and (ii) at least one known cosmetic effect of each of the plurality of first ingredients. The operations further include training a machine learning model for predicting cosmetic effects of ingredients using (i) the set of properties of the plurality of first ingredients and (ii) the at least one known cosmetic effect of each of the plurality of first ingredients. The operations also include obtaining a set of properties for a second ingredient having unknown cosmetic effects. The operations further include applying the set of properties for the second ingredient having unknown cosmetic effects to the machine learning model to predict the cosmetic effect for the second ingredient.

According to other aspects of the present disclosure, the computing device may include one or more of the following features. The instructions may further cause the computing device to simulate effects of the second ingredient on a virtual person over time based on the set of properties for the second ingredient by depicting changes to images of the virtual person's face over time with the second ingredient applied. The instructions may further cause the computing device to generate a formulation for a new beauty product which includes the second ingredient based on the predicted cosmetic effect for the second ingredient. The formulation of the new beauty product may include a plurality of ingredients including the second ingredient and a ratio for each of the plurality of ingredients indicating an amount of each ingredient to include in the new beauty product. The instructions may further cause the computing device to simulate effects of the new beauty product on a virtual person over time by depicting changes to images of the virtual person's face over time with the new beauty product applied. To generate the formulation for the new beauty product, the instructions may cause the computing device to apply the second ingredient to a generative artificial intelligence (AI) model to generate the formulation of the new beauty product, wherein the generative AI model is trained on existing beauty products and corresponding ingredients of the existing beauty products to learn a relationship between the existing beauty products and the corresponding ingredients. The generative AI model may be further trained to identify a complementary property to the set of properties for the second ingredient, and generate the formulation to include an additional ingredient to the second ingredient having the complementary property. The set of properties and the at least one known cosmetic effect of each of the plurality of first ingredients may be obtained at least in part from sensor data indicating real-time cosmetic effects of the plurality of first ingredients on consumers as the consumers use beauty products with the plurality of first ingredients.

According to another aspect of the present disclosure, a non-transitory computer-readable medium storing instructions thereon is provided. When executed by one or more processors, the instructions cause the one or more processors to perform operations. The operations include, for each of a plurality of first ingredients having known cosmetic effects, obtaining (i) a set of properties of each of the plurality of first ingredients, and (ii) at least one known cosmetic effect of each of the plurality of first ingredients. The operations further include training a machine learning model for predicting cosmetic effects of ingredients using (i) the set of properties of the plurality of first ingredients and (ii) the at least one known cosmetic effect of each of the plurality of first ingredients. The operations also include obtaining a set of properties for a second ingredient having unknown cosmetic effects. The operations further include applying the set of properties for the second ingredient having unknown cosmetic effects to the machine learning model to predict the cosmetic effect for the second ingredient.

According to other aspects of the present disclosure, the non-transitory computer-readable medium may include one or more of the following features. The instructions may further cause the one or more processors to simulate effects of the second ingredient on a virtual person over time based on the set of properties for the second ingredient by depicting changes to images of the virtual person's face over time with the second ingredient applied. The instructions may further cause the one or more processors to generate a formulation for a new beauty product which includes the second ingredient based on the predicted cosmetic effect for the second ingredient. The formulation of the new beauty product may include a plurality of ingredients including the second ingredient and a ratio for each of the plurality of ingredients indicating an amount of each ingredient to include in the new beauty product.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an example computing environment for predicting the cosmetic effects of ingredients using machine learning, according to some aspects.

FIG. 2 illustrates a flow diagram of an example method for training a machine learning model to predict the cosmetic effects of ingredients, according to some aspects.

FIG. 3 is a combined block and logic diagram for training a generative AI model to generate a formulation of a new beauty product using a new ingredient, according to some aspects.

FIG. 4 depicts a display of a virtual person’s face at a first point in time before a new ingredient or new beauty product has been applied, according to some aspects.

FIG. 5 depicts a display of the virtual person’s face at a second point in time after the new ingredient or new beauty product has been applied, illustrating the changes and effects simulated over a specified period, according to some aspects.

FIG. 6 depicts a display of the virtual person’s face at a third point in time after the new ingredient or new beauty product has been applied, showing further changes and the long-term effects of the cosmetic ingredient or beauty product, according to some aspects.

FIG. 7 is a flow diagram of an example method for predicting cosmetic effects of ingredients using machine learning techniques, according to some aspects.

### DETAILED DESCRIPTION

The present techniques introduce a comprehensive approach to predicting the cosmetic effects of ingredients using ML and AI technologies. These techniques encompass a method and system that leverage advanced ML algorithms to analyze a wide array of data, including but not limited to in vivo, in vitro, clinical studies data, product use-case data, product safety data, and consumer feedback data. The core of these techniques lies in the ability to predict the cosmetic effects of new ingredients and formulations, such as reducing wrinkles, firming skin, and improving hair volume, among others. This predictive capability is achieved through the training of a machine learning model using properties of ingredients with known cosmetic effects, alongside sensor data indicating real-time cosmetic effects of these ingredients on consumers.

By utilizing a machine learning model to predict cosmetic effects based on ingredient properties, these techniques streamline the research and development process in cosmetology. This model reduces the need for extensive physical testing, thereby saving time and resources. The machine learning model is trained to understand the relationship between ingredient properties and their cosmetic effects, enabling quick and accurate predictions for new ingredients with unknown effects.

The virtual testing platform introduces a way to simulate the effects of new ingredients and beauty products on a virtual person over time. This platform utilizes a 3D simulation module for realistic rendering of skin and hair reactions, alongside a sensitivity analysis module and an ingredient compatibility module. These simulations offer a safe, cost-effective, and rapid means of testing, significantly advancing the pace of research in cosmetology. By depicting changes to images of a virtual person's face over time, the platform provides valuable insights into the potential cosmetic outcomes of applying certain ingredients or products.

Moreover, the present techniques utilize a generative AI model for formulating new beauty products. Trained on existing beauty products and their ingredients, this model learns the relationship between ingredients and their effects, enabling it to generate formulations for new products that are likely to achieve desired cosmetic outcomes. This model also identifies complementary properties of ingredients, ensuring that the formulations are balanced and effective.

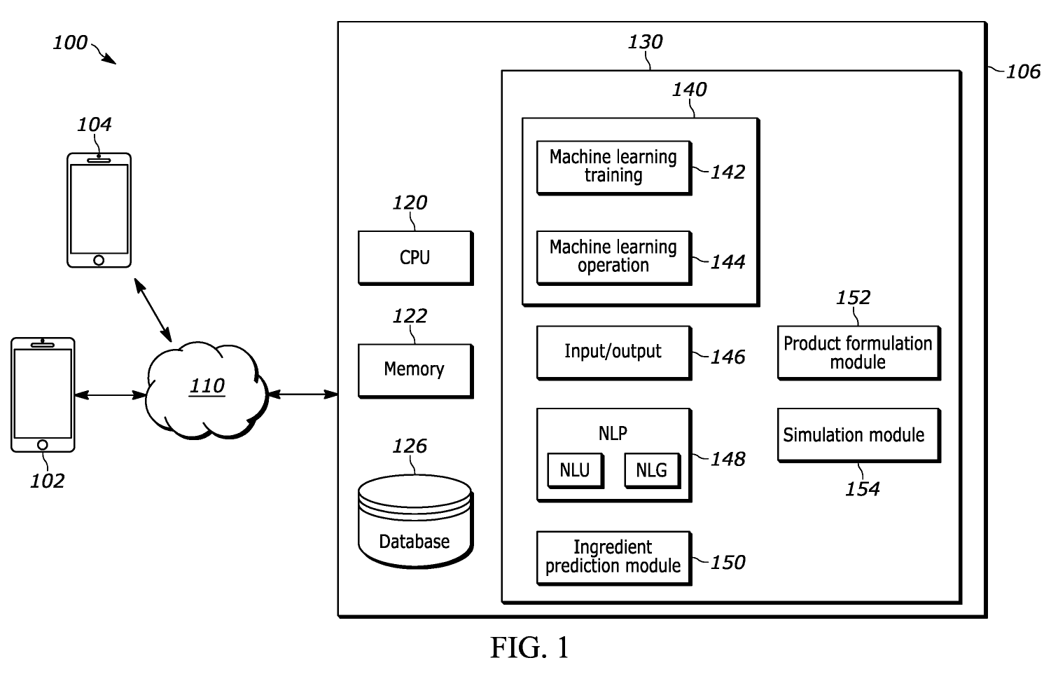

FIG. 1 illustrates an exemplary new beauty product formulation environment 100 associated with predicting the cosmetic effects of ingredients using machine learning, generating new beauty product formulations based on the predicted cosmetic effects of the ingredients, and virtually simulating the cosmetic effects of ingredients or new beauty products on virtual people in a virtual testing environment. Although FIG. 1 depicts certain entities, components, equipment, and devices, it should be appreciated that additional or alternate entities, components, equipment, and devices are envisioned.

The environment 100 may include consumer client devices 102, a simulator client device 104, and a server 106. The consumer client devices 102, simulator client device 104 and server 106 may be communicatively coupled via an electronic network 110.

As shown in FIG. 1, the environment 100 may include consumer client devices 102 associated with consumers who use beauty products. The consumer client device 102 may be any suitable device, including one or more computers, mobile devices, wearables, smart watches, smart contact lenses, smart glasses, augmented reality glasses, virtual reality headsets, mixed or extended reality glasses or headsets, and/or other electronic or electrical components. The consumer client device 102 may include a memory and a processor for, respectively, storing and executing one or more modules. The memory may include one or more suitable storage media such as a magnetic storage device, a solid-state drive, random access memory (RAM), etc. The consumer client device 102 may access services or other components of the new beauty product formulation 100 via the network 110.

Additionally, the consumer client device 102 may include sensors, such as an image sensor (e.g., a camera), a positioning sensor (e.g., a GPS), a depth sensor (e.g., a light detection and ranging (lidar) sensor), an accelerometer, or any other suitable sensors. The consumer client device 102 may collect sensor data as the consumer uses a beauty product, such as images of the consumer over time as the consumer uses the beauty product. The consumer client device 102 may then provide the sensor data to the server 106 which may analyze the sensor data to identify cosmetic effects of ingredients in the beauty product. For example, if Beauty Product B has Ingredient A as the main ingredient, and the sensor data for several consumers using Beauty Product B shows reduced wrinkles after repeated usage of the beauty product, the server 106 may determine that Ingredient A has the cosmetic effect of reducing wrinkles.

The environment 100 may also include a simulator client device 104. The simulator client device 104 may be any suitable device for communication, including one or more computers, mobile devices, wearables, smart watches, smart contact lenses, smart glasses, augmented reality glasses, virtual reality headsets, mixed or extended reality glasses or headsets, telephones, and/or other electronic or electrical components. The simulator client device 104 may include a memory and a processor for, respectively, storing and executing one or more modules. The memory may include one or more suitable storage media such as a magnetic storage device, a solid-state drive, random access memory (RAM), etc. The simulator client device 104 may communicate with other components of the new beauty product formulation environment 100 via the network 110.

Additionally, the simulator client device 104 may include a display for presenting simulations of the cosmetic effects of an ingredient/new beauty product on a virtual person over time. The display may present a two-dimensional (2D) or three-dimensional (3D) rendering of the virtual person’s face at a first point in time before the ingredient/new beauty product has been applied to the virtual person. Then the display may depict changes to the virtual person’s face over time as the ingredient/new beauty product is applied to the virtual person’s face.

In one aspect, one or more servers 106 may perform functionalities as part of a cloud network or may otherwise communicate with other hardware or software components within one or more cloud computing environments to send, retrieve, or otherwise analyze data or information described herein. For instance, in certain aspects of the present techniques, the new beauty product formulation environment 100 may comprise an on-premise computing environment, a multi-cloud computing environment, a public cloud computing environment, a private cloud computing environment, and/or a hybrid cloud computing environment. For example, an entity (e.g., a beauty brand) may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the beauty brand). Alternatively, or in addition, aspects of the public cloud may be hosted on-premise at a location owned/controlled by an enterprise generating the beauty content. The public cloud may be partitioned using virtualization and multi-tenancy techniques and may include one or more infrastructure-as-a-service (IaaS) and/or platform-as-a-service (PaaS) services.

A network 110 may comprise any suitable network or networks, including a local area network (LAN), wide area network (WAN), the Internet, or a combination thereof. For example, the network 110 may include a wireless cellular service (e.g., 4G, 5G, 6G, etc.). Generally, the network 110 enables bidirectional communication between the servers 106, consumer client devices 102, and simulator client device 104. In one aspect, the network 110 may comprise a cellular base station, such as cell tower(s), communicating to the one or more components of the beauty content generation environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the new beauty product formulation environment 100 via wireless communications based upon any one or more of various wireless standards, including by non-limiting example, IEEE 802.11a/b/c/g (Wi-Fi), Bluetooth, and/or the like.

The server 106 may include one or more processors 120. The processors 120 may include one or more suitable processors (e.g., central processing units (CPUs) and/or graphics processing units (GPUs)). The processors 120 may be connected to a memory 122 via a computer bus (not depicted) responsible for transmitting electronic data, data packets, or otherwise electronic signals to and from the processors 120 and memory 122 in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 122 via a computer bus to execute an operating system (OS) and/or computing instructions contained therein, and/or to access other services/aspects. For example, the processors 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer-based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine-readable instructions, methods, processes, elements, or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code, or the like (e.g., via Golang, Python, C, C++, C#, Objective-C, Java, Scala, ActionScript, JavaScript, HTML, CSS, XML, etc.).

The database 126 may be a relational database, such as Oracle, DB2, MySQL, a NoSQL-based database, such as MongoDB, or another suitable database. The database 126 may store data that is used to train and/or operate one or more ML models, provide augmented reality models/displays, among other things.

In one aspect, the computing modules 130 may include an ingredient prediction module 150 that predicts the cosmetic effects of ingredients, a product formulation module 152 that generates a new beauty product formulation based on the predicted cosmetic effects of the ingredients, and a simulation module 154 that generates and provides a simulation of the cosmetic effects of an ingredient/new beauty product on a virtual person’s face.

The ingredient prediction module 150 and the product formulation module 152 both utilize a machine learning (ML) module 140 for generating an ML model to predict the cosmetic effect(s) of an ingredient and to generate a formulation for a new beauty product having specified cosmetic effect(s).

The ML module 140 may include an ML training module (MLTM) 142 and/or an ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforcement learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML-based algorithms may be included as a library or package executed on the server(s) 106. For example, libraries may include the TensorFlow-based library, the HuggingFace library, the PyTorch library, and/or the scikit-learn Python library.

In one embodiment, the ML module 140 employs supervised learning, which involves identifying patterns in existing data to make predictions about subsequently received data. Specifically, the ML module 140 is “trained” (e.g., via MLTM 142) using training data, which includes example inputs and associated example outputs. Based upon the training data, the ML module 140 may generate a predictive function that maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

More specifically, the ML module 140 may be trained using the properties of ingredients having known cosmetic effects. For example, the ML module 140 may be trained using a first ingredient having a first set of properties and a first cosmetic effect, a second ingredient having a second set of properties and a second cosmetic effect, a third ingredient having a third set of properties and a third cosmetic effect, etc. The properties of the ingredients may include chemical properties, colors, scents, acidity levels, hydrophilic or hydrophobic characteristics, moisturizing effects, textures, and other relevant attributes.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization, and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 102 (for rendering or visualizing) described herein. In one aspect, the servers 106 may include a client-server platform technology such as ASP.NET, Java J2EE, Ruby on Rails, Node.js, a web service or online API, responsible for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch-sensitive input panels, keys, buttons, lights, LEDs), which may be directly accessible via, or attached to, servers 106 or may be indirectly accessible via or attached to the user device 102. According to one aspect, an administrator or operator may access the servers 106 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU), and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In some embodiments, the ingredient prediction module 150 discussed herein may be configured to utilize AI and/or ML techniques. More specifically, the ingredient prediction module 150 may obtain a set of properties for a new ingredient having unknown cosmetic effects. The ingredient prediction module 150 may apply the set of properties to the ML model generated by ML module 140 to predict the cosmetic effect(s) of the new ingredient. Then the ingredient prediction module 150 may provide predicted cosmetic effect(s) of the new ingredient for display to a user (e.g., via the simulator client device 104), so that the new ingredient can be used or tested in a new beauty product. As used herein the term “new ingredient” may refer to any ingredient having unknown cosmetic effects. The new ingredient may be a known ingredient which has not been tested in cosmetics.

Also in some embodiments, the product formulation module 152 discussed herein may be configured to utilize AI and/or ML techniques. The ML module 140 may employ supervised or unsupervised ML techniques, which may be followed by, and/or used in conjunction with, reinforced or reinforcement learning techniques to generate a generative AI model for generating new beauty product formulations.

For example, the generative AI model may be trained using a supervised dataset of ingredients, types of beauty products (e.g., foundation, lipstick, mascara, eye liner, concealer, etc.), properties of the ingredients (e.g., beneficial effects, scents, chemical properties, acidity levels), and/or complementary properties of other ingredients as inputs. For each ingredient, the supervised dataset may include a set of existing beauty products that use the ingredient, and a list of ingredients and their respective amounts within each existing beauty product in the set. In this manner, the generative AI model may be trained to generate formulations having certain ratios of each ingredient based on the ingredients and their respective ratios in existing beauty products. The product formulation module 152 may employ the techniques utilized for ChatGPT or Google Bard.

In any event, the product formulation module 152 may provide an ingredient and/or a set of properties of the ingredient to the generative AI model generated by the ML module 140. The generative AI model may generate a new beauty product formulation using the ingredient and provide the formulation to the product formulation module 152. Then the product formulation module 152 may provide the new beauty product formulation for display to a user (e.g., via the simulator client device 104). Additionally or alternatively, the product formulation module 152 may provide the new beauty product formulation to the simulator module 154.

The simulator module 154 may simulate the cosmetic effects of a new ingredient/new beauty product in a virtual cosmetic testing system. More specifically, the simulator module 154 may execute a Monte Carlo simulation to simulate changes to a virtual person’s face over time as the new ingredient/new beauty product is applied to the virtual person’s face. The simulator module 154 may randomly select a set of facial features for the virtual person. Then the simulator module 154 applies the new ingredient or beauty product to the virtual person's face, using predicted probabilities of different cosmetic effects provided by the ML module 140. These probabilities account for the ingredient's properties and its interaction with the virtual person's unique characteristics. The simulator module 154 then renders an image of the virtual person’s face after the new ingredient/new beauty product has been applied based on the results of the simulation. The simulator module 154 may provide the rendered image or image data to the simulator client device 104 to display the results of the simulation.

Noted above, in some embodiments, the ingredient prediction module 150 and the product formulation module 152 may be configured to implement ML, such that server 106 “learns” to analyze, organize, and/or process data without being explicitly programmed. ML may be implemented through ML methods and algorithms (“ML methods and algorithms”). In one exemplary embodiment, the ML module 140 may be configured to implement ML methods and algorithms.

Although the new beauty product formulation environment 100 is shown to include one consumer client device 102, one simulator client device 104, one server 106, and one network 110, it should be understood that different numbers of consumer client devices 102, simulator client devices 104, servers 106, and/or networks 110 may be utilized.

The new beauty product formulation environment 100 may include additional, fewer, and/or alternate components, and may be configured to perform additional, fewer, or alternate actions, including components/actions described herein. Although the new beauty product formulation environment 100 is shown in FIG. 1 as including one instance of various components such as consumer client devices 102, simulator client devices 104, servers 106, networks 110, etc., various aspects include the new beauty product formulation environment 100 implementing any suitable number of any of the components shown in FIG. 1 and/or omitting any suitable ones of the components shown in FIG. 1. For instance, information described as being stored at server database 126 may be stored at memory 122, and thus database 126 may be omitted. Moreover, various aspects include the new beauty product formulation environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 106 and consumer client device 102 may be connected via a direct communication link (not shown in FIG. 1) instead of, or in addition to, via network 110.

In general, training the ML model for predicting the cosmetic effect(s) of ingredients may include establishing a network architecture, or topology, and adding layers that may be associated with one or more activation functions (e.g., a rectified linear unit, softmax, etc.), loss functions and/or optimization functions. Multiple different types of artificial neural networks may be employed, including without limitation, recurrent neural networks, convolutional neural networks, and deep learning neural networks. Data sets used to train the artificial neural network(s) may be divided into training, validation, and testing subsets; these subsets may be encoded in an N-dimensional tensor, array, matrix, or other suitable data structures. Training may be performed by iteratively training the network using labeled training samples. Training of the artificial neural network may produce byproduct weights, or parameters which may be initialized to random values. The weights may be modified as the network is iteratively trained, by using one of several gradient descent algorithms, to reduce loss and to cause the values output by the network to converge to expected, or “learned,” values.

In one embodiment, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In some embodiments, multiple artificial neural networks may be separately trained and operated, and/or separately trained and operated in conjunction.

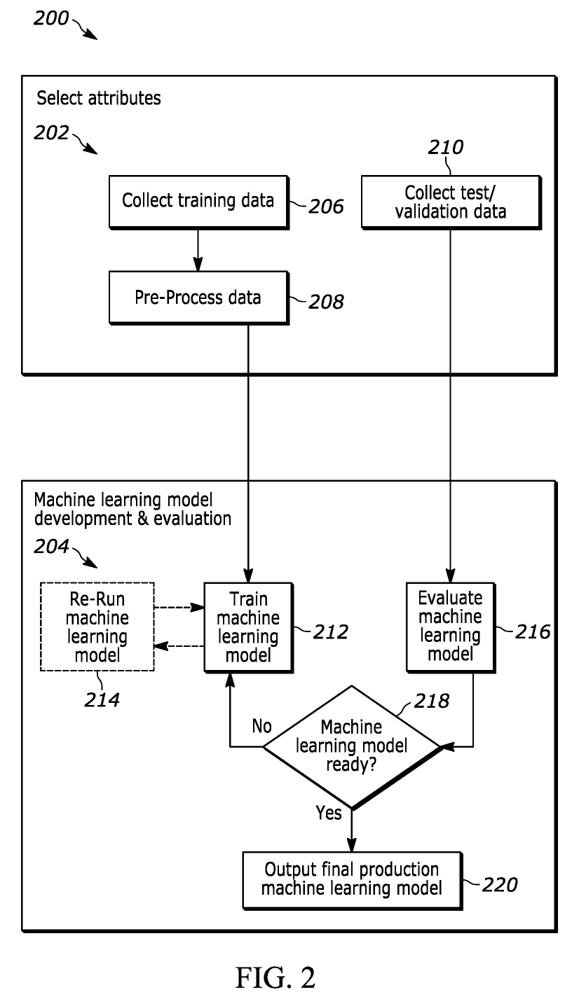

FIG. 2 illustrates a flow diagram of an example machine learning modeling method 200 for training a machine learning model (e.g., a machine learning algorithm), to predict the cosmetic effects of ingredients. It should be understood that the principles of FIG. 2 may apply to any machine learning algorithm discussed herein.

As illustrated in the example of FIG. 2, in some embodiments, the model “learns” an algorithm capable of predicting the cosmetic effect(s) of a new ingredient. At a high level, the machine learning modeling method 200 includes a block 202 for preparation of model input data, and a block 204 for model training and evaluation. The model training, storage, and implementation may be performed at the server 106 or any other suitable component. In some embodiments, the training, storage, and implementation steps of the machine learning model may be performed at different computing devices or servers.

Depending on implementation, the ML model may be trained based upon supervised learning, unsupervised learning, or semi-supervised learning. Such learning paradigms may include reinforcement learning. Supervised learning is a learning process for learning the underlying function or algorithm that maps an input to an output based on example input-output combinations. A “teaching process” compares predictions by the model to known answers (labeled data) and makes corrections in the model. The trained algorithm is then able to make predictions of outputs based on the inputs. In such embodiments, the data (e.g., properties of ingredients, such as chemical properties, colors, scents, acidity levels, hydrophilic or hydrophobic characteristics, moisturizing effects, textures, etc.) may be labeled according to the corresponding output (e.g., cosmetics effect of the ingredients).

Unsupervised learning is a learning process for generalizing the underlying structure or distribution in unlabeled data. In embodiments utilizing unsupervised learning, the system may rely on unlabeled ingredient properties, such as chemical properties, colors, scents, acidity levels, hydrophilic or hydrophobic characteristics, moisturizing effects, textures, etc. During unsupervised learning, natural structures are identified and exploited for relating instances to each other. Semi-supervised learning can use a mixture of supervised and unsupervised techniques. This learning process discovers and learns the structure in the input variables, where typically some of the input data is labeled, and most is unlabeled. The training operations discussed herein may rely on any one or more of supervised, unsupervised, or semi-supervised learning with regard to the order data and delivery data, depending on the embodiment.

Block 202 may include any one or more blocks or sub-blocks 306-310, which may be implemented in any suitable order. At block 206, the MLTM 142, may obtain training data from the consumer client device 102 or any suitable computing devices. The training data may include for several ingredients, a set of properties of the ingredient, and the known cosmetic effect(s) of the ingredient. The training data may be obtained from cosmetic studies or other data sources that indicate the cosmetic effects of ingredients. The training data may also be obtained from scientific journals or other sources which indicate the properties of ingredients.

Initially, at block 208, relevant data may be selected from among available data (e.g., historical data). Training data may be assessed and cleaned, including handling missing data and handling outliers. For example, missing records, zero values (e.g., values that were not recorded), incomplete data sets (e.g., for scenarios when data collection was not completed), outliers, and inaccurate and/or inconclusive data may be removed. In order to select high predictive value features, special feature engineering techniques may be used to derive useful features from the datasets. For example, data may be visualized for the underlying relationships to determine which feature engineering steps should be assessed for performance improvement. This step may include manually entering user input, for example via a user interface, which may include defining possible predictive variables for the machine learning model. Manual user input may also include manually including or excluding variables selection after running special feature engineering techniques. Manual user input may be guided by an interest to evaluate, for example, an interaction of two or more predictor variables (e.g., which data source the data came from).

Furthermore, at block 208, various measures may be taken to ensure a robust set of training data (e.g., providing standardized, heterogeneous data, removing outliers, imputing missing values, and so on). In certain embodiments, special feature engineering techniques may be used to extract or derive the best representations of the predictor variables to increase the effectiveness of the model. To avoid overfitting, in some embodiments feature reduction may be performed. In some embodiments, feature engineering techniques may include an analysis to remove uncorrelated features or variables.

Variables may be evaluated in isolation to eliminate low predictive value variables, for example, by applying a cut-off value. For instance, some variables may have low predictive values for particular property parameters.

At block 210, the MLTM 142 receives test data for testing the model or validation data for validating the model (e.g., from one of the described respective data sources). Some or all of the training, test, or validation data sets may be labeled with pre-determined answers (e.g., based upon known information, predicted information, etc.).

Block 204 illustrates an example machine learning model development and evaluation phase. Block 204 may include any one or more blocks or sub-blocks 212-220, which may be implemented in any suitable order. In one example, at block 212, the MLTM 142 trains the machine learning model by running one or more pre-processed training data sets described above. At block 214, the MLTM 142 re-runs several iterations of the machine learning model. At block 216, the MLTM 142 evaluates the machine learning model. At block 218, the MLTM 142 determines whether or not the machine learning model is ready for deployment before either proceeding to block 220 to output final production model or returning to block 212 to further develop, test, or validate the model.

Regarding block 212, developing the model typically involves training the model using training data. At a high level, the machine learning model may be utilized to discover relationships between various observable features (e.g., between predictor features and target features) in a training dataset, which can then be applied to an input dataset to predict unknown values for one or more of these features given the known values for the remaining features. At block 204, these relationships are discovered by feeding the model pre-processed training data including instances each having one or more predictor feature values and one or more target feature values. The model then “learns” an algorithm capable of calculating or predicting the target feature values (e.g., to predict the cosmetic effect(s) of an ingredient) given the predictor feature values (e.g., the properties of the ingredient). For example, during pre-processing, the ingredient properties may be numerically encoded. The MLTM 142 may train an ML model e.g., using neural networks or gradient boosting to predict probabilities of an ingredient having various cosmetic effects by classifying the numerical encodings of ingredient properties into groups based on the respective cosmetic effects associated with the ingredients.

At block 212, the machine learning model may be trained (e.g., by the MLTM 142) to thereby generate the machine learning model. Techniques for training/generating the machine learning model may include gradient boosting, neural networks, deep learning, linear regression, polynomial regression, logistic regression, support vector machines, decision trees, random forests, nearest neighbors, or any other suitable machine learning technique. In some examples, the MLTM 142 implements gradient boosting machine learning with a secondary application of the model for close cases and/or error correction. In certain embodiments, training the machine learning model may include training more than one model according to the selected method(s) on the data pre-processed at block 208 implementing different method(s) and/or using different sub-sets of the training data, or according to other criteria.

Training the machine learning model may include re-running the model (at optional block 214) to improve the accuracy of prediction values. For example, re-running the model may improve model training when implementing gradient boosting machine learning. In another implementation, re-running the model may be necessary to assess the differences caused by an evaluation procedure. For instance, available data sets may be split into training and testing data sets by randomly assigning sub-sets of data to be used to train the model or evaluate the model to meet the predefined train or test set size, or an evaluation procedure may use a k-fold cross validation. Both of these evaluation procedures are stochastic, and, as such, each evaluation of a deterministic ML model, even when running the same algorithm, provides a different estimate of error or accuracy. The performance of these different model runs may be compared using one or more accuracy metrics, for example, as a distribution with mean expected error or accuracy and a standard deviation. In certain implementations, the models may be evaluated using metrics such as root mean square error (RMSE), to measure the accuracy of prediction values.

Regarding block 216, evaluating the model typically involves testing the model using testing data or validating the model using validation data. Testing/validation data typically includes both predictor feature values and target feature values (e.g., including order demand patterns for which corresponding delivery patterns are known), enabling comparison of target feature values predicted by the model to the actual target feature values, enabling one to evaluate the performance of the model. This testing/validation process is valuable because the model, when implemented, will generate target feature values for future input data that may not be easily checked or validated. Thus, it is advantageous to check one or more accuracy metrics of the model on data for which the target answer is already known (e.g., testing data or validation data), and use this assessment as a proxy for predictive accuracy on future data. Example accuracy metrics include key performance indicators, comparisons between historical trends and predictions of results, cross-validation with subject matter experts, comparisons between predicted results and actual results, etc.

Regarding block 218, the MLTM 142 may utilize any suitable set of metrics to determine whether or not to proceed to block 220 to output the final production model. Generally speaking, the decision to proceed to block 220 or to return to block 212 will depend on one or more accuracy metrics generated during evaluation (block 216). After the sub-blocks 212-218 of block 204 have been completed, the MLTM 142 may implement block 220. At block 220, the machine learning model is output.

Then for an ingredient having unknown cosmetic effect(s), the ingredient prediction module 152 may obtain a set of properties for the ingredient and apply them to the ML model via the MLOM 144 to predict the cosmetic effect(s) of the ingredient. The cosmetic effects may include reducing wrinkles, firming skin, reducing the signs of aging, replacing lost moisture in skin, improving hair volume, controlling frizz, etc.

The new beauty product formulation system 100 may then use the predicted cosmetic effect(s) of the new ingredient to generate a formulation for a new beauty product using the new ingredient. The formulation may include a combination of ingredients in addition to the new ingredient and a ratio for each of the ingredients indicating an amount of each ingredient to include in the new beauty product.

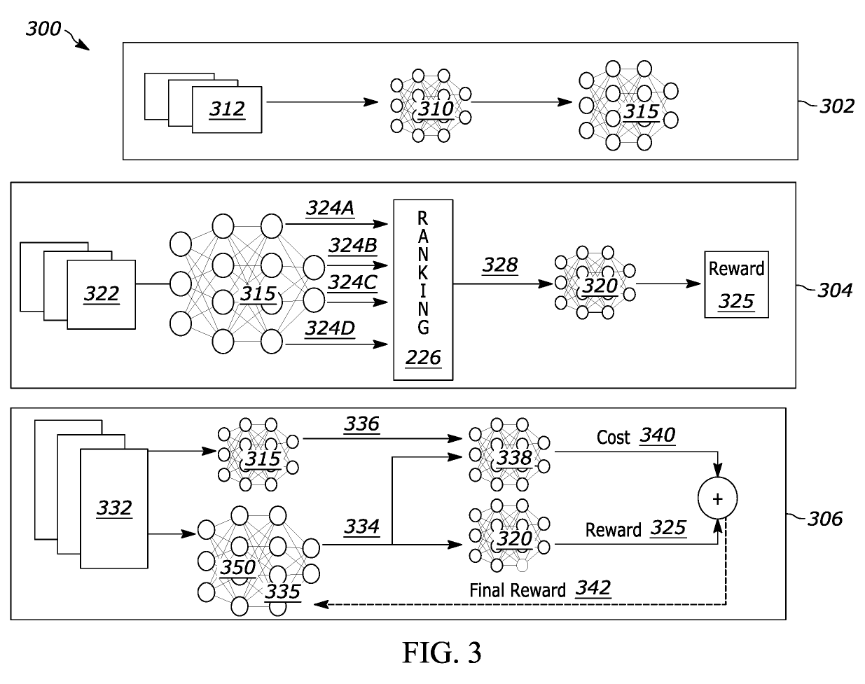

FIG. 3 is a combined block and logic diagram for training a generative AI model (e.g., a GAN) to generate a formulation of a new beauty product using a new ingredient. Some blocks in FIG. 3 may represent hardware and/or software components, others may represent data structures or memory storing these data structures, registers, or state variables (e.g., data structures for cosmetic effects of ingredients 312), and other blocks may represent output data (e.g., 325). Input and/or output signals may be represented by arrows labeled with corresponding signal names and/or other identifiers. The methods and systems may include one or more servers 302, 304, 306 which may be implemented as one or more modules of the server 106.

The system and methods to generate and/or train a generative AI model (e.g., via the ML module 140 of the server 106) may consist of three steps: (1) a Supervised Fine-Tuning (SFT) step where a pretrained language model (e.g., an LLM) may be fine-tuned on a relatively small amount of demonstration data curated by human labelers to learn a supervised policy (SFT ML model) which may generate outputs (e.g., formulations) from a selected list of inputs (e.g., ingredients, types of beauty products (e.g., foundation, lipstick, mascara, eye liner, concealer, etc.), properties of the ingredients (e.g., beneficial effects, scents, chemical properties, acidity levels), and/or complementary properties of other ingredients). The SFT ML model may represent a cursory model for what may be later developed and/or configured as the generative AI model; (2) a reward model step where human labelers may rank numerous SFT ML model outputs to evaluate the outputs which best mimic preferred human outputs, thereby generating comparison data. The reward model may be trained on the comparison data; and/or (3) a policy optimization step in which the reward model may further fine-tune and improve the SFT ML model. The outcome of this step may be the generative AI model using an optimized policy. In one aspect, step one may take place only once, while steps two and three may be iterated continuously, e.g., more comparison data is collected on the current generative AI model, which may be used to optimize/update the reward model and/or further optimize/update the policy.

In one aspect, to generate the formulation, the server 302 may fine-tune a pretrained language model 310. The pretrained language model 310 may be obtained by the server 302 and be stored in a memory, such as memory 122 and/or database 126. The pretrained language model 310 may be loaded into an ML training module by the server 302 for retraining/fine-tuning. A supervised training dataset 312 may be used to fine-tune the pretrained language model 310 wherein each ingredient input to the pretrained language model 310 may have a known product formulation output for the pretrained language model 210 to learn from. The supervised training dataset 312 may be stored in a memory of the server 302, e.g., the memory 122 or the database 126. In one aspect, the data labelers may create the supervised training dataset 312 having ingredient inputs and appropriate formulation outputs. In addition to including ingredients as data inputs, the supervised training dataset 312 may also include types of beauty products (e.g., foundation, lipstick, mascara, eye liner, concealer, etc.), properties of the ingredients (e.g., beneficial effects, scents, chemical properties, acidity levels), and/or complementary properties of other ingredients, etc. as data inputs.

The pretrained language model 310 may be fine-tuned using the supervised training dataset 312 resulting in the SFT ML model 315 which may provide appropriate formulation outputs in response to ingredient inputs once trained. The trained SFT ML model 315 may be stored in a memory of the server 302, e.g., memory 122 and/or database 126. The ingredient inputs and formulations outputs may come from existing beauty products.

In one aspect, training the generative AI model 350 may include the server 304 training a reward model 320 to provide as an output a scaler value/reward 325. The reward model 320 may be required to leverage Reinforcement Learning with Human Feedback (RLHF) in which a model (e.g., generative AI model 350) learns to produce outputs which maximize its reward 335, and in doing so may provide formulation outputs which are better aligned to ingredient inputs.

Training the reward model 320 may include the server 304 providing a single ingredient input 322 to the SFT ML model 315 as an input. The ingredient input 322 may be provided via an input device (e.g., a keyboard) via the I/O module of the server, such as I/O module 146. The ingredient input 322 may be previously unknown to the SFT ML model 315, e.g., the labelers may generate new ingredients. The SFT ML model 315 may generate multiple, different formulation outputs 324A, 324B, 324C, 324D to the ingredient input 322. The server 304 may output the formulation outputs 324A, 324B, 324C, 324D via an I/O module (e.g., I/O module 146) to a user interface device, such as a display (e.g., as text), a speaker (e.g., as audio), and/or any other suitable manner of output of the formulation outputs 324A, 324B, 324C, 324D for review by the data labelers.

The data labelers may provide feedback via the server 304 on the formulation outputs 324A, 324B, 324C, 324D when ranking 326 them from best to worst based upon the input-output pairs. The data labelers may rank 326 the formulations outputs 324A, 324B, 324C, 324D by labeling the associated data. The ranked input-output pairs 328 may be used to train the reward model 320. In one aspect, the server 304 may load the reward model 220 via the ML module and train the reward model 320 using the ranked response pairs 328 as input. The reward model 320 may provide as an output the scalar reward 325.

In one aspect, the scalar reward 325 may include a value numerically representing a human preference for the best and/or most expected formulation outputs for an ingredient input, i.e., a higher scaler reward value may indicate the user is more likely to prefer that formulation output, and a lower scalar reward may indicate that the user is less likely to prefer that formulation output. For example, inputting the “winning” input-output pair data to the reward model 320 may generate a winning reward. Inputting a “losing” input-output pair data to the same reward model 320 may generate a losing reward. The reward model 320 and/or scalar reward 325 may be updated based upon labelers ranking 326 additional input-output pairs generated in response to additional beauty trend inputs 322.

While the reward model 320 may provide the scalar reward 325 as an output, the reward model 320 may not generate a formulation output. Rather, the scalar reward 325 may be used by a version of the SFT ML model 315 to generate more accurate formulation outputs for ingredient inputs, i.e., the SFT model 315 may generate the formulation output for an ingredient input, and the reward model 320 may receive the formulation output to generate a scalar reward 325 of how well humans perceive it. Reinforcement learning may optimize the SFT model 315 with respect to the reward model 320 which may realize the configured generative AI model 350.

In one aspect, the server 306 may train the generative AI model 350 to generate a formulation output 334 to a random, new and/or previously unknown ingredient input 332. To generate the formulation output 334, the generative AI model 350 may use a policy 335 (e.g., algorithm) which it learns during training of the reward model 320, and in doing so may advance from the SFT model 315 to the generative AI model 350. The policy 335 may represent a strategy that the generative AI model 350 learns to maximize its reward 325. As discussed herein, based upon input-output pairs, a human labeler may continuously provide feedback to assist in determining how well the generative AI model’s 350 formulation outputs match expected formulation outputs to determine rewards 325. The rewards 325 may feed back into the generative AI model 350 to evolve the policy 335. Thus, the policy 335 may adjust the parameters of the generative AI model 350 based upon the rewards 325 it receives for generating good responses. The policy 335 may update as the generative AI model 350 provides formulation outputs 334 to additional ingredient inputs 332.

In other implementations, the SFT ML model 315 may provide the formulations to a discriminator to compare each formulation to machine-generated formulations and formulations in existing beauty products. The discriminator may determine whether each formulation is more like the machine-generated formulations or the existing beauty product formulations and may provide a reward to each formulation accordingly. The ML module 140 then learns a policy based on the training with the discriminator to maximize the reward. The ML module 140 uses this policy to update the generative AI model 350 and generate new formulations.

For example, using the supervised dataset, the generative AI model 350 may “learn” that 90% of lipsticks include at least 5% of ingredient X. Thus, the generative AI model 350 may be likely to include ingredient X in a new lipstick formulation. In another example, using the supervised dataset, the generative AI model 350 may “learn” that foundations with Vitamin Y also typically include Vitamin Z. Therefore, the generative AI model 350 may include Vitamin Z in the foundation if the formulation includes Vitamin Y.

The generative AI model 350 also may be trained to identify properties of ingredients and identity other properties which are complementary to those properties in some way using the supervised dataset which includes the properties of ingredients and the complementary properties of other ingredients. For example, complementary properties may include an acid and a base to balance out the pH level of a product. In another example, complementary properties may include a pleasant odor for an ingredient that is mixed with an odorless ingredient. In yet another example, complementary properties may include two ingredients having similar beneficial effects, where the combination of the ingredients enhances the beneficial effects. For example, Vitamin X and Vitamin Y may have similar benefits but it may not be recommended for a consumer to have more than a certain amount of Vitamin X. Accordingly, the combination of Vitamin X and Vitamin Y may result in a larger beneficial effect without the harmful effects associated with too much of Vitamin X or Vitamin Y. This capability is crucial for creating balanced and effective formulations.

In one aspect, the formulation output 334 of the generative AI model 350 using the policy 335 based upon the reward 325 may be compared using a cost function 338 to the SFT ML model 315 (which may not use a policy) formulation output 336 of the same ingredient input 332. The server 306 may compute a cost 340 based upon the cost function 338 of the formulation outputs 334, 336. The cost 340 may reduce the distance between the formulation outputs 334, 336, i.e., a statistical distance measuring how one probability distribution is different from a second, in one aspect the formulation output 334 of the generative AI model 350 versus the formulation output 336 of the SFT model 315. Using the cost 340 to reduce the distance between the formulation outputs 334, 336 may avoid a server over-optimizing the reward model 320 and deviating too drastically from the human-intended/preferred formulation output. Without the cost 340, the generative AI model 350 optimizations may result in generating formulation outputs 334 which are unreasonable but may still result in the reward model 320 outputting a high reward 325.

In one aspect, the formulation outputs 334 of the generative AI model 350 using the current policy 335 may be passed by the server 306 to the rewards model 320, which may return the scalar reward or discount 325. The generative AI model 350 formulation output 334 may be compared via cost function 338 to the SFT ML model 315 formulation output 336 by the server 306 to compute the cost 340. The server 306 may generate a final reward 342 which may include the scalar reward 325 offset and/or which may be restricted by the cost 340. The final reward or discount 342 may be provided by the server 306 to the generative AI model 350 and may update the policy 335, which in turn may improve the functionality of the generative AI model 350.

To optimize the generative AI model 350 over time, RLHF via the human labeler feedback may continue ranking 326 output of the generative AI model 350 versus outputs of earlier/other versions of the SFT ML model 315, i.e., providing positive or negative rewards or adjustments 325. The RLHF may allow the servers (e.g., servers 304, 306) to continue iteratively updating the reward model 320 and/or the policy 335. As a result, the generative AI model 350 may be retrained and/or fine-tuned based upon the human feedback via the RLHF process, and throughout continuing conversations may become increasingly efficient.

Although multiple servers 302, 304, 306 are depicted in the exemplary block and logic diagram 300, each providing one of the three steps of the overall generative AI model 350 training, fewer and/or additional servers may be utilized and/or may provide the one or more steps of the generative AI model 350 training. In one aspect, one server 106 may provide the entire generative AI model 350 training.

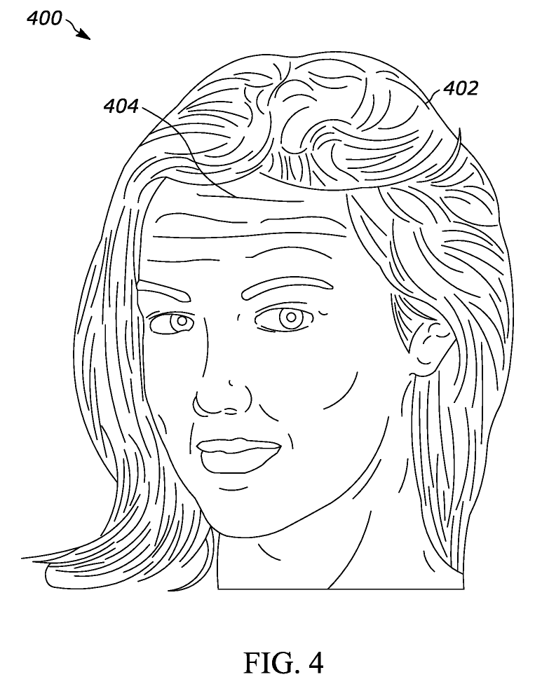

FIG. 4 depicts a display 400 of a virtual person's face 402 at a first point in time before a new ingredient or new beauty product has been applied to the virtual person's face. The display 400 shows a computer-generated representation of a virtual person's face and hair presented on a client device, such as the simulator client device 104. The simulation module 154 randomly selects the virtual person's facial features, skin tone, skin conditions, and other properties to create a diverse and realistic representation. In this example, the virtual person has fine lines 404 on their forehead.

The display 400 presents a front-facing view of the virtual person's face 402, showcasing various facial elements such as the eyes, nose, mouth, cheeks, and forehead. The skin tone of the virtual person may range from fair to dark, reflecting the diversity of real-world skin tones. The skin condition may exhibit various characteristics such as dryness, oiliness, or any suitable combination skin types. Additionally, the virtual person's face 402 may display common skin concerns like fine lines, wrinkles, blemishes, or uneven skin texture, depending on the randomly assigned age and skin properties.

The simulation module 154 also renders the hair of the virtual person, with variations in color, length, texture, and style. This adds to the overall realism and individuality of the virtual person's appearance.

The simulator client device 104 may present this image with high resolution and detail, allowing users to closely examine the virtual person's facial features and skin condition. This initial image serves as a baseline for comparison, representing the virtual person's appearance before the application of any new ingredient or beauty product.

The randomization of facial features, skin properties, and other characteristics ensures that the virtual testing system can simulate the effects of new ingredients or beauty products on a wide range of skin types and conditions. This diversity in virtual subjects allows for more comprehensive and realistic predictions of how a new ingredient or product might perform across different demographics and skin types.

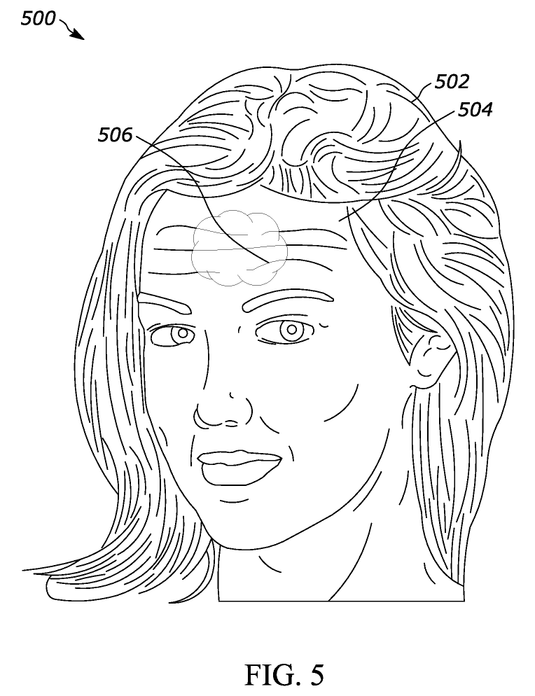

FIG. 5 depicts a display 500 of the virtual person's face at a second point in time 502 after the new ingredient or new beauty product 506 has been applied to the virtual person's face (e.g., 7 days later), where the display shows changes to the virtual person's face according to results of a simulation of the cosmetic effects of the new ingredient or new beauty product from the first point in time to the second point in time.

The display 500 shows the same virtual person's face 502 as in FIG. 4, but with visible changes resulting from the simulated application of the new ingredient or beauty product. These changes may include improvements in skin texture, reduction of fine lines or wrinkles, changes in skin tone or coloration, or other effects predicted by the machine learning model and simulated over the 7-day period. As shown in FIG. 5, the new beauty product (a cream) 506 is applied to the virtual person’s forehead and some of the fine lines 504 have been reduced.

To generate this image, the simulation module 154 uses a Monte Carlo simulation to model the probabilistic nature of cosmetic effects on a diverse population of virtual people. The simulation takes into account various factors such as age, skin type, allergies, and other individual characteristics. For each virtual person, the simulation runs multiple iterations, each representing a possible outcome based on the predicted probabilities of different cosmetic effects.

The Monte Carlo simulation process can be described mathematically as follows:

1. For each virtual person i, define a set of characteristics Cᵢ = {cᵢ₁, cᵢ₂, ..., cᵢₙ} where each c represents a specific characteristic (e.g., age, skin type).

2. Let P(Eⱼ|Cᵢ) be the probability of cosmetic effect Eⱼ given characteristics Cᵢ, as predicted by the machine learning model described in FIG. 2.

3. For each iteration k of the simulation:

a. Generate a random number rₖ ~ U(0,1)

b. If rₖ < P(Eⱼ|Cᵢ), apply effect Eⱼ to the virtual person

4. Repeat steps 3a and 3b for multiple iterations to build a distribution of possible outcomes.

5. Aggregate the results across all iterations to determine the most likely outcome for each virtual person.

The simulation module 154 then uses the results of the simulation to render the image of the virtual person's face 502 at the second point in time. The rendering process applies the simulated changes to the original image, adjusting parameters such as skin texture, coloration, and other relevant features to reflect the predicted cosmetic effects.

In some implementations, the ML module 140 can update the machine learning model described in FIG. 2 using the results of this simulation. For example, the ML module 140 may include the cosmetic effect(s) of the ingredient in the new beauty product from the simulation as additional training data. This feedback loop allows the system to continuously learn and adapt its predictions based on the simulated results.

Furthermore, the results of the simulation can be used to assign a reward to the generative AI model 350 described in FIG. 3. Better cosmetic outcomes from the simulation may result in larger rewards 325. For example, if the simulation shows significant improvement in skin texture or reduction of fine lines, the generative AI model 350 that produced the formulation for the new beauty product would receive a higher reward 325. This reinforcement learning approach encourages the generative AI model 350 to learn to generate formulations that maximize the reward, potentially leading to more effective beauty products over time.

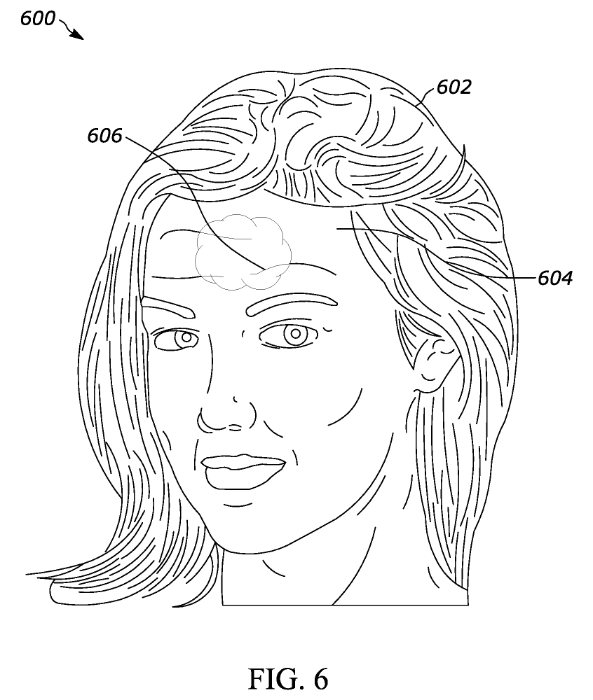

FIG. 6 depicts a display 600 of the virtual person's face at a third point 602 in time after the new ingredient or new beauty product 606 has been applied to the virtual person's face (e.g., 30 days later), where the display 600 shows changes to the virtual person's face according to results of the simulation of the cosmetic effects of the new ingredient or new beauty product from the second point in time to the third point in time.

The display 600 shows the same virtual person's face 602 as shown in FIG. 5, but with further changes resulting from the continued simulations of the new ingredient or beauty product over an extended period. These changes may include more pronounced improvements in skin texture, further reduction of fine lines or wrinkles, additional changes in skin tone or coloration, or other long-term effects predicted by the machine learning model and simulated over the 30-day period. As shown in FIG. 6, the fine lines 604 have been significantly reduced.

The simulation module 154, as described in FIG. 1, continues to execute Monte Carlo simulation to model the probabilistic nature of cosmetic effects over this longer timeframe. This simulation takes into account the cumulative effects of continued use of the new ingredient or beauty product, as well as potential variations in efficacy over time.

The ML module 140 can update the machine learning model described in FIG. 2 using the results of this extended simulation. By comparing the simulated long-term outcomes to real-world data collected from consumers using the new ingredient or beauty product over an extended period, the model can be further refined to improve its predictive accuracy for long-term cosmetic effects. This feedback loop allows the system to continuously learn and adapt its predictions based on both simulated and real-world results over various time scales.

The results of the extended simulation can also be used to assign an updated reward to the generative AI model 350 described in FIG. 3. Cosmetic outcomes that show sustained or increasing improvement over time may result in larger rewards. For example, if the simulation shows continued improvement in skin texture or progressive reduction of fine lines over the 30-day period, the generative AI model 350 that produced the formulation for the new beauty product would receive a higher reward. This reinforcement learning approach encourages the generative AI model 350 to learn to generate formulations that not only provide immediate benefits but also deliver sustained or improving results over time.

By incorporating this extended timeframe simulation, the system enhances its ability to predict and visualize both short-term and long-term cosmetic effects. This comprehensive approach allows for more accurate assessment of a new ingredient or beauty product's efficacy over time, potentially leading to the development of products with sustained benefits for consumers.

By integrating the machine learning model from FIG. 2, the generative AI model from FIG. 3, and the simulation capabilities demonstrated in FIGS. 4-6, the virtual testing system creates a comprehensive framework for predicting, testing, and visualizing the cosmetic effects of new ingredients and beauty products. This approach allows for rapid iteration and optimization in product development, potentially reducing the time and cost associated with bringing new beauty products to market.

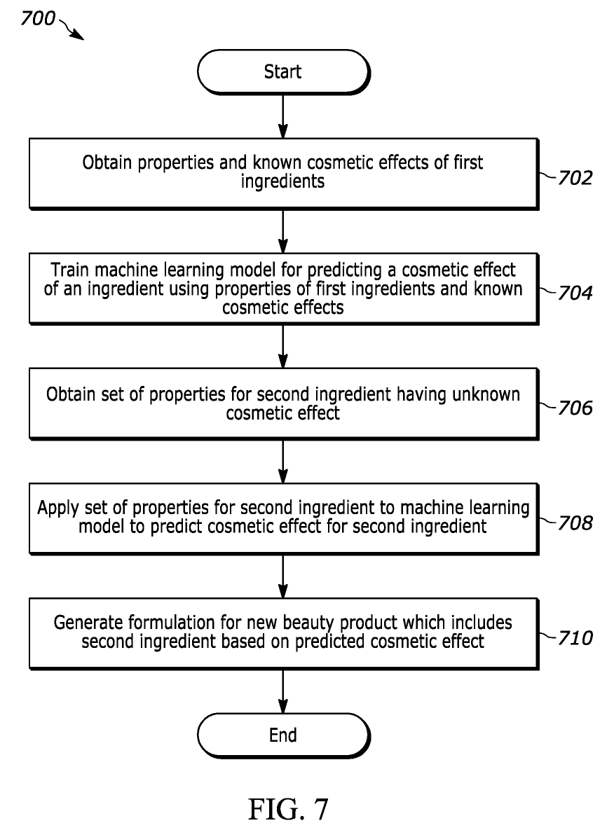

FIG. 7 is a flow diagram of an example method 700 for predicting cosmetic effects of ingredients using machine learning techniques. The method 700 may be implemented by the server 106, which may utilize the ML module 140, to predict the cosmetic effects of new ingredients based on their properties and known effects of other ingredients.

The method begins with obtaining a set of properties for each of a plurality of first ingredients having known cosmetic effects, along with at least one known cosmetic effect for each of these ingredients (block 702). These properties may include chemical properties, colors, scents, acidity levels, hydrophilic or hydrophobic characteristics, moisturizing effects, textures, and other relevant attributes. The known cosmetic effects can include reducing wrinkles, firming skin, reducing signs of aging, replacing lost moisture in skin, improving hair volume, controlling frizz, and other observable effects on appearance or skin/hair condition.

Next, the method 700 includes training a machine learning model for predicting cosmetic effects of ingredients (block 704). The ML module 140 of the server 106 trains this model using the sets of properties of the plurality of first ingredients as predictor feature values and the known cosmetic effects of each first ingredient as target feature values. This training process, detailed with reference to FIG. 2, involves feeding the properties of the first ingredients as inputs to the model and the known cosmetic effects as the target output, allowing the model to learn the relationships between ingredient properties and their cosmetic effects.

The method then proceeds to obtain a set of properties for a second ingredient having unknown cosmetic effects (block 706). This second ingredient may be a newly developed compound or a natural ingredient that has not been extensively studied for cosmetic applications.

Finally, the trained machine learning model is applied to predict the cosmetic effect for the second ingredient (block 708). The set of properties for the second ingredient is input into the model, which then outputs predicted cosmetic effects based on the learned relationships from the training data. This prediction process leverages the relationships learned during the training phase to estimate the likely cosmetic effects of the new ingredient based on its properties.

In some implementations, the method 700 may include additional steps. For example, the server 106 may simulate the effects of the second ingredient on a virtual person over time. This simulation, as described with references FIGS. 4-6, may use the results of a Monte Carlo simulation to depict changes to the virtual person’s face over time after the second ingredient has been applied to their face, providing a visual representation of the predicted cosmetic effects.

The method 700 may also involve generating a formulation for a new beauty product that includes the second ingredient. This formulation is based on the predicted cosmetic effect for the second ingredient and may include multiple ingredients with specified ratios indicating the amount of each ingredient to include in the new beauty product.

To generate this formulation, the server 106 may apply the second ingredient to a generative AI model, as described with reference to FIG. 3. This generative AI model is trained on existing beauty products and their corresponding ingredients to learn relationships between products and ingredients. The model may also be trained to identify complementary properties and include additional ingredients with these complementary properties in the formulation.

The method 700 can further include simulating the effects of the new beauty product on a virtual person over time. This simulation depicts changes to images of the virtual person's face over time with the new beauty product applied, allowing for visualization of the predicted long-term effects of the complete formulation.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A method for predicting cosmetic effects of ingredients using machine learning techniques, the method comprising:
for each of a plurality of first ingredients having known cosmetic effects, obtaining, by one or more processors, (i) a set of properties of each of the plurality of first ingredients, and (ii) at least one known cosmetic effect of each of the plurality of first ingredients;
training, by the one or more processors, a machine learning model for predicting cosmetic effects of ingredients using (i) the set of properties of the plurality of first ingredients and (ii) the at least one known cosmetic effect of each of the plurality of first ingredients;
obtaining, by the one or more processors, a set of properties for a second ingredient having unknown cosmetic effects; and
applying, by the one or more processors, the set of properties for the second ingredient having unknown cosmetic effects to the machine learning model to predict the cosmetic effect for the second ingredient.

2. The method of claim 1, further comprising:
simulating, by the one or more processors, effects of the second ingredient on a virtual person over time based on the set of properties for the second ingredient by depicting changes to images of the virtual person’s face over time with the second ingredient applied.

3. The method of claim 1, further comprising:
generating, by the one or more processors, a formulation for a new beauty product which includes the second ingredient based on the predicted cosmetic effect for the second ingredient.

4. The method of claim 3, wherein the formulation of the new beauty product includes a plurality of ingredients including the second ingredient and a ratio for each of the plurality of ingredients indicating an amount of each ingredient to include in the new beauty product.

5. The method of claim 3, further comprising:
simulating, by the one or more processors, effects of the new beauty product on a virtual person over time by depicting changes to images of the virtual person’s face over time with the new beauty product applied.

6. The method of claim 3, wherein generating the formulation for the new beauty product includes:
applying, by the one or more processors, the second ingredient to a generative artificial intelligence (AI) model to generate the formulation of the new beauty product, wherein the generative AI model is trained on existing beauty products and corresponding ingredients of the existing beauty products to learn a relationship between the existing beauty products and the corresponding ingredients.

7. The method of claim 6, wherein the generative AI model is further trained to:
identify a complementary property to the set of properties for the second ingredient; and
generate the formulation to include an additional ingredient to the second ingredient having the complementary property.

8. The method of claim 1, wherein the set of properties and the at least one known cosmetic effect of each of the plurality of first ingredients are obtained at least in part from sensor data indicating real-time cosmetic effects of the plurality of first ingredients on consumers as the consumers use beauty products with the plurality of first ingredients.

9. A computing device for predicting cosmetic effects of ingredients using machine learning techniques, the computing device comprising:
one or more processors; and
a non-transitory computer-readable medium storing instructions thereon that, when executed by the one or more processors, cause the computing device to:
for each of a plurality of first ingredients having known cosmetic effects, obtain (i) a set of properties of each of the plurality of first ingredients, and (ii) at least one known cosmetic effect of each of the plurality of first ingredients;
train a machine learning model for predicting cosmetic effects of ingredients using (i) the set of properties of the plurality of first ingredients and (ii) the at least one known cosmetic effect of each of the plurality of first ingredients;
obtain a set of properties for a second ingredient having unknown cosmetic effects; and
apply the set of properties for the second ingredient having unknown cosmetic effects to the machine learning model to predict the cosmetic effect for the second ingredient.

10. The computing device of claim 9, wherein the instructions further cause the computing device to:
simulate effects of the second ingredient on a virtual person over time based on the set of properties for the second ingredient by depicting changes to images of the virtual person’s face over time with the second ingredient applied.

11. The computing device of claim 9, wherein the instructions further cause the computing device to:
generate a formulation for a new beauty product which includes the second ingredient based on the predicted cosmetic effect for the second ingredient.

12. The computing device of claim 11, wherein the formulation of the new beauty product includes a plurality of ingredients including the second ingredient and a ratio for each of the plurality of ingredients indicating an amount of each ingredient to include in the new beauty product.

13. The computing device of claim 11, wherein the instructions further cause the computing device to:
simulate effects of the new beauty product on a virtual person over time by depicting changes to images of the virtual person’s face over time with the new beauty product applied.

14. The computing device of claim 11, wherein to generate the formulation for the new beauty product, the instructions cause the computing device to:
apply the second ingredient to a generative artificial intelligence (AI) model to generate the formulation of the new beauty product, wherein the generative AI model is trained on existing beauty products and corresponding ingredients of the existing beauty products to learn a relationship between the existing beauty products and the corresponding ingredients.

15. The computing device of claim 14, wherein the generative AI model is further trained to:
identify a complementary property to the set of properties for the second ingredient; and
generate the formulation to include an additional ingredient to the second ingredient having the complementary property.

16. The computing device of claim 9, wherein the set of properties and the at least one known cosmetic effect of each of the plurality of first ingredients are obtained at least in part from sensor data indicating real-time cosmetic effects of the plurality of first ingredients on consumers as the consumers use beauty products with the plurality of first ingredients.

17. A non-transitory computer-readable medium storing instructions thereon that, when executed by one or more processors, cause the one or more processors to:
for each of a plurality of first ingredients having known cosmetic effects, obtain (i) a set of properties of each of the plurality of first ingredients, and (ii) at least one known cosmetic effect of each of the plurality of first ingredients;
train a machine learning model for predicting cosmetic effects of ingredients using (i) the set of properties of the plurality of first ingredients and (ii) the at least one known cosmetic effect of each of the plurality of first ingredients;
obtain a set of properties for a second ingredient having unknown cosmetic effects; and
apply the set of properties for the second ingredient having unknown cosmetic effects to the machine learning model to predict the cosmetic effect for the second ingredient.

18. The non-transitory computer-readable medium of claim 17, wherein the instructions further cause the one or more processors to:
simulate effects of the second ingredient on a virtual person over time based on the set of properties for the second ingredient by depicting changes to images of the virtual person’s face over time with the second ingredient applied.

19. The non-transitory computer-readable medium of claim 17, wherein the instructions further cause the one or more processors to:
generate a formulation for a new beauty product which includes the second ingredient based on the predicted cosmetic effect for the second ingredient.

20. The non-transitory computer-readable medium of claim 19, wherein the formulation of the new beauty product includes a plurality of ingredients including the second ingredient and a ratio for each of the plurality of ingredients indicating an amount of each ingredient to include in the new beauty product.
